(19) United States
(12) Patent Application Publication
(10) Pub. No.: US 2005/0111116 A1
(43) Pub. Date: May 26, 2005

(54) Thread coupled lens barrel

(76) Inventors: Taketoshi Okajima, Saitama-shi (JP); Hidemi Asano, Saitama-shi (JP)

Correspondence Address: JACOBSON HOLMAN PLLC, 400 SEVENTH STREET N.W., SUITE 600, WASHINGTON, DC, 20004, US

(21) Appl. No.: 10/996,407

(22) Filed: Nov. 26, 2004

(30) Foreign Application Priority Data
Nov. 26, 2003 (JP) 2003-395712

(51) Int. Cl. G02B 15/14

(52) U.S. Cl. 359/819

(57) ABSTRACT

An object of the present invention is to provide a thread coupled lens barrel which can be manufactured easily by using inexpensive members and in which both parts in the thread engagement without any gap or back-lash in the thread engagement site can be aligned with high precision along a center axis line or an optical axis. Provided is a thread coupled lens barrel having a thread engagement site, characterized in that an elastic synthetic resin tape is disposed between a female thread and a male thread in said thread engagement site and a state of thread engagement is secured by a fixing screw. Also provided is another thread coupled lens barrel having a thread engagement site, characterized in that an elastic synthetic resin tape is disposed between a female thread and a male thread in said thread engagement site and a thread engaged rotation between said female thread and said male thread relative to each other in said thread engagement site is made possible.

### FIELD OF THE INVENTION

The present invention generally relates to a thread coupled lens barrel, and more specifically to a thread coupled lens barrel in which thread engagement in a thread coupled site can be provided in a high precision so that a thread engaged rotation can be carried out smoothly without any back-lash.

### DESCRIPTION OF THE PRIOR ART

It has been required that the thread engagement in threaded portions is configured with high precision and further both parts in the thread engagement without any gap or back-lash in the thread engagement site should be aligned with high precision along a center axis line or an optical axis. It is still further required that if the thread engagement parts are adapted to rotate with respect to each other, the rotation should be carried out smoothly.

In one configuration suggested to satisfy those requirements, as shown in FIG. 3, a bolt 300 is provided with a recessed portion 304 in an intermediate location of a threaded section 302 formed in the direction orthogonal to the axial line of the bolt 300. An elastic member 310 made of such synthetic resin known as Teflon (Trademark) or the like may be fitted into the recessed portion 304 such that its outer surface protrudes slightly beyond a surface of outer diameter of thread. A base board or a nut 322 provided with a female thread 320 to be brought into thread engagement with the threaded section 302 is engaged with the threaded section 302. The female thread 320 progressively advances a thread engagement while deforming the elastic member. The elastic member 310 functions to make the thread engagement smooth through its elastic deformation while supporting an engaged condition. The elastic member 310 may employ any material so far as it has a resiliency and allows the female thread to invade thereinto including, for example, hard rubber (see, for example, Patent Document No.1).

On one hand, a technique for providing said elastic member by winding a stretchable tape made of elastic material around the engaging site between an internal thread portion and an external thread portion has been used in a water pipe laying work and/or a gas pipe laying work for coupling the pipes. This stretchable tape is provided for a purpose that, after it has been wound around a surface of a male thread while being deformed and stretched following a contour of the male thread surface, the stretchable tape is further deformed during the engagement with a female thread so as to fill the space between the female thread and the male thread in order to achieve an air-tight or liquid-tight blocking in the engagement site. Therefore, it is essential that the female thread and the male thread should be engaged with each other as deep as possible. [Patent Document No.1] Japanese Patent Laid-open publication No. Hei7-63214

### SUMMERY OF THE INVENTION

In the technology as disclosed in the Patent Document No.1, a hole must be formed in the treaded portion of a bolt, into which the elastic member is to be embedded, and it is extremely difficult to apply this mechanical processing to be the threaded portion. Further, due to such a configuration that the hole is arranged in one side with respect to the axial line of the threaded portion, where the elastic member is to be embedded, the elastic member is deformed while biasing the nut toward the one side with respect to the axial line of the bolt, and in this configuration, if there is a back-lash or gap between the bolt and the nut, it could not be avoided that the back-lash causes an off-center arrangement of the nut with respect to the bolt.

### OBJECT OF THE INVENTION

The present invention has been made in the light of the above-pointed problems in association with the prior art, and an object thereof is to provide a thread coupled lens barrel which can be manufactured easily by using inexpensive members and in which both parts in the thread engagement without any gap or back-lash in the thread engagement site can be aligned with high precision along a center axis line or an optical axis.

Another object of the present invention is to provide a thread coupled lens barrel allowing for a smooth rotation free from a back-lash, which only requires a simple processing of the engaging portions without the need for any processing or treatment of high precision.

Still another object of the present invention is to provide a thread coupled lens barrel which allows a degree of engagement in the engaging portions representing a depth adjusting margin defined by a dimension of engagement of the female threaded portion with the male threaded portion to be increased uniformly, that is, for example, such a thread coupled lens barrel in which a travel for adjustment of a constituent lens along the optical axis can be increased while the high precision thereof being kept as it was.

According to a first aspect of the present invention there is provided a thread coupled lens barrel having a thread engagement site, characterized in that an elastic synthetic resin tape is disposed between a female thread and a male thread in said thread engagement site and a state of thread engagement is secured by a fixing screw.

According to a second aspect of the present invention there is provided a thread coupled lens barrel having a thread engagement site, characterized in that an elastic synthetic resin tape is disposed between a female thread and a male thread in said thread engagement site and a thread engaged rotation between said female thread and said male thread relative to each other in said thread engagement site is made possible.

Preferred embodiments of the present invention will be described below.

An embodiment of the present invention is characterized in that said elastic synthetic resin tape is made of polytetrafluoroethylene.

An alternative embodiment of the present invention is characterized in that said elastic synthetic resin has been applied with an adhesive on one side thereof.

The thread coupled lens barrel according to the present invention can bring about an effect that said lens barrel can be manufactured easily by using inexpensive members and that both parts in the thread engagement without any gap or back-lash in the thread engagement site can be aligned with high precision along the center axis line or the optical axis.

The thread coupled lens barrel according to the present invention can bring about an effect that the smooth rotation free from a back-lash can be provided only by the simple processing of the engaging portions without the need for any processing or treatment of high precision.

### BRIEF DESCRIPTION OF THE DRAWINGS

FIG. 1 is a sectional view of a thread coupled lens barrel according to a first embodiment of the present invention;

FIG. 2 is a sectional view of a thread coupled lens barrel according to a second embodiment of the present invention; and

FIG. 3 is a sectional view of an adjusting bolt according to the prior art.

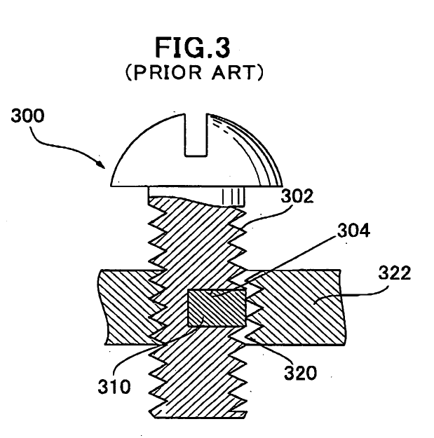

### BEST MODE FOR CARRYING OUT THE INVENTION

A best mode for carrying out the present invention will now be described below.

### FIRST EMBODIMENT

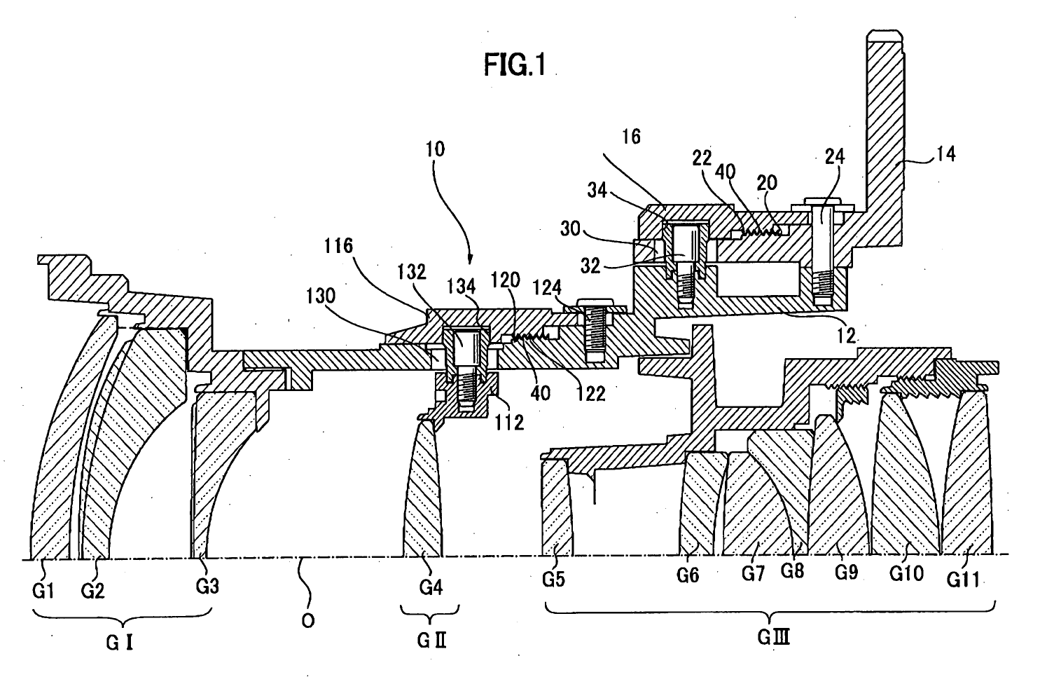

A thread coupled lens barrel 10 according to a first embodiment represents that for a projector lens as shown in FIG. 1, and it holds a first lens group GI consisting of lenses G1 to G3, a second lens group GII consisting of a lens G4 and a third lens group GIII consisting of lenses G5 to G11.

The thread coupled lens barrel 10 has a first lens holding frame 12 for holding all of the lenses G1 to G11 and a lens mount 14.

A “focusing adjustment section” of the thread coupled lens barrel 10 performs a focusing adjusting by moving the first lens holding frame 12 holding all of the lenses G1 to G11 along the optical axis O relative to the lens mount 14.

A focusing adjustment ring 16 rotatably supported on the lens mount 14 has a first female thread 20 A first lens holding frame 12 has a first male thread 22 to be thread engaged with the first female thread 20. The first lens holding frame 12 is fixed to the lens mount 14 by a first fixing screw 24. The lens mount 14 has a first linear slot 30 formed in parallel with the optical axis O. A first coma 32 implanted in the first holding frame 12 penetrates through the first linear slot 30 and is engaged with a first inner circumferential groove 34 provided in an inner surface of the focusing adjustment ring 16.

To assemble the focusing adjustment section of the thread coupled lens barrel 10, firstly polytetrafluoroethylene tape 40 having a thickness of 0.1 mm, for example, is wound around the first male thread 22. The polytetrafluoroethylene tape 40 may be applied with the adhesive on one side thereof. The polytetrafluoroethylene tape 40 may be replaced with alternative tape made of other material having small frictional resistance and good stretchability.

The first female thread 20 is thread-engaged with the first male thread 22 wound with the polytetrafluoroethylene tape 40, and the focusing adjustment ring 16 is rotated to thereby change a degree of the thread engagement. Thereby, the focusing adjustment ring 16 is moved along the optical axis O, so that the position of the first lens holding frame 12 holding the lenses G1 to G11 can be adjusted via the first coma 32 engaged with the first inner circumferential groove 34, thus performing the focusing adjustment. When the desired focusing condition has been achieved, a first fixing screw 24 is fastened to thereby secure the focused condition.

A “magnification adjustment section” of the thread coupled lens barrel 10 performs the magnification adjustment by moving the second lens holding frame 112 holding the lens G4 along the optical axis O relative to the first lens holding frame 12.

A magnification adjustment ring 116 rotatably supported on the first lens holding frame 12 has a second female thread 120. The second lens holding frame 112 has a second male thread 122 to be thread-engaged with the second female thread 120. The second lens holding frame 112 is fixed to the first lens holding frame 12 by a second fixing screw 124. The first lens holding frame 12 has a second linear slot 130 formed in parallel with the optical axis O. A second coma 132 implanted in the second lens holding frame 112 penetrates through the second linear slot 130 and is engaged with a second inner circumferential groove 134 formed in an inner surface of the magnification adjustment ring 116.

To assemble the magnification adjustment section of the thread coupled lens barrel 10, firstly the polytetrafluoroethylene tape 40 having a thickness of 0.1 mm is wound around the second male thread 122.

The second female thread 120 is thread-engaged with the second male thread 122 wound with the polytetrafluoroethylene tape 40, and the magnification adjustment ring 116 is rotated to thereby change a degree of the thread engagement. Thereby, the magnification adjustment ring 116 is moved along the optical axis O, so that the position of the second lens holding frame 112 holding the lens G4 can be adjusted via the second coma 132 engaged with the second inner circumferential groove 134, thus performing the magnification adjustment. When the desired magnification condition has been achieved, a second fixing screw 124 is fastened to thereby secure the condition of the desired magnification.

### SECOND EMBODIMENT

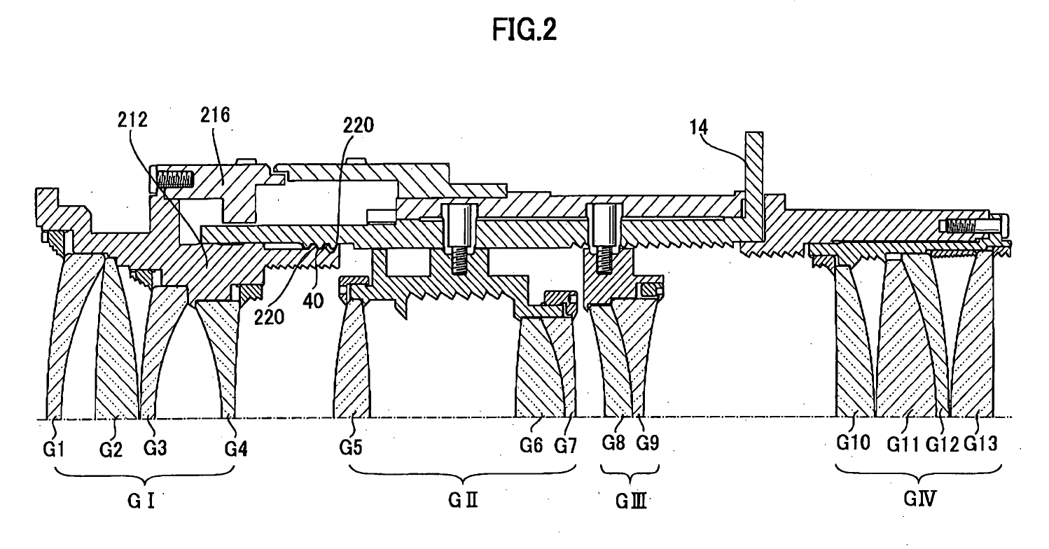

A thread coupled lens barrel 210 according to a second embodiment is that for a projector lens as shown in FIG. 2, and it holds a first lens group GI consisting of lenses G1 to G4, a second lens group GII consisting of lens G5 to G7, a third lens group GIII consisting of lenses G8 and G9 and a fourth lens group GIV consisting of lenses G10 to G13.

The “focusing section” of the thread coupled lens barrel 210 performs a focusing operation or a focusing by moving a third lens holding frame 212 holding the first lens group G1 along an optical axis O relative to a lens mount 14.

The focusing ring 216 rotatably supported by the lens mount 14 is fixedly secured to the third lens holding frame 212 which has a male thread or a male helicoid 222. The lens mount 14 has a female helicoid 220 to be thread-engaged with the male helicoid 222.

To assemble the focusing section of the thread coupled lens barrel 210, firstly a polytetrafluoroethylene tape 40 having a thickness of 0.1 mm is wound around the male helicoid 222.

The female helicoid 220 is thread-engaged with the male helicoid 222 wound with the polytetrafluoroethylene tape 40.

Industrial Applicability

Although the present invention has been described with reference to the embodiments representing the thread engagement and the helicoid engagement applied to the focusing adjustment section, the magnification adjustment section and the focusing operation section, it may be effectively embodied in a zooming operation section and a filter rotational operation section as well.

1. A thread coupled lens barrel having a thread engagement site, characterized in that an elastic synthetic resin tape is disposed between a female thread and a male thread in said thread engagement site and a state of thread engagement is secured by a fixing screw.

2. A thread coupled lens barrel in accordance with claim 1, in which said elastic synthetic resin tape is made of polytetrafluoroethylene.

3. A thread coupled lens barrel in accordance with claim 1, in which said elastic synthetic resin has been applied with an adhesive on one side thereof.

4. A thread coupled lens barrel having a thread engagement site, characterized in that an elastic synthetic resin tape is disposed between a female thread and a male thread in said thread engagement site and a thread engaged rotation between said female thread and said male thread relative to each other in said thread engagement site is made possible.

5. A thread coupled lens barrel in accordance with claim 3, in which said elastic synthetic resin tape is made of polytetrafluoroethylene.

6. A thread coupled lens barrel in accordance with claim 3, in which said elastic synthetic resin has been applied with an adhesive on one side thereof.
